(19) United States
(12) Patent Application Publication
(10) Pub. No.: US 2008/0028181 A1
(43) Pub. Date: Jan. 31, 2008

(54) DEDICATED MECHANISM FOR PAGE MAPPING IN A GPU

(75) Inventors: Peter C. Tong, Cupertino, CA (US); Sonny S. Yeoh, San Jose, CA (US); Kevin J. Kranzusch, Campbell, CA (US); Gary D. Lorensen, San Jose, CA (US); Kaymann L. Woo, Milpitas, CA (US); Ashish Kishen Kaul, San Carlos, CA (US); Colyn S. Case, Hyde Park, VT (US); Stefan A. Gottschalk, Chapel Hill, NC (US); Dennis K. Ma, Austin, TX (US)

Correspondence Address: TOWNSEND AND TOWNSEND AND CREW LLP, TWO EMBARCADERO CENTER, 8TH FLOOR, SAN FRANCISCO, CA, 94111-3834, US

(73) Assignee: NVIDIA Corporation, Santa Clara, CA (US)

(21) Appl. No.: 11/689,485

(22) Filed: Mar. 21, 2007

Related U.S. Application Data
(60) Provisional application No. 60/820,952, filed on Jul. 31, 2006.
(60) Provisional application No. 60/821,127, filed on Aug. 1, 2006.

(51) Int. Cl. G06F 12/00

(52) U.S. Cl. 711/207

(57) ABSTRACT

Circuits, methods, and apparatus that reduce or eliminate system memory accesses to retrieve address translation information. In one example, these accesses are reduced or eliminated by pre-populating a graphics TLB with entries that are used to translate virtual addresses used by a GPU to physical addresses used by a system memory. Translation information is maintained by locking or restricting entries in the graphics TLB that are needed for display access. This may be done by limiting access to certain locations in the graphics TLB, by storing flags or other identifying information in the graphics TLB, or by other appropriate methods. In another example, memory space is allocated by a system BIOS for a GPU, which stores a base address and address range. Virtual addresses in the address range are translated by adding them to the base address.

### CROSS-REFERENCES TO RELATED APPLICATIONS

This application claims the benefit of U.S. provisional applications Nos. 60/820,952, filed Jul. 31, 2006 and 60/821,127, filed Aug. 1, 2006, both titled DEDICATED MECHANISM FOR PAGE-MAPPING IN A GPU, by Tong et al., both of which are incorporated by reference.

This application is related to co-owned and co-pending U.S. patent application Ser. No. 11/253,438, filed Oct. 18, 2005, titled Zero Frame Buffer; Ser. No. 11/077,662, filed Mar. 10, 2005, titled Memory Management for Virtual Address Space with Translation Units of Variable Range Size; and Ser. No. 11/077,662, filed Mar. 10, 2005, titled Memory Management for Virtual Address Space with Translation Units of Variable Range Size, which are incorporated by reference.

### BACKGROUND

The present invention relates to eliminating or reducing system memory accesses to retrieve address translation information required for system memory display data accesses.

Graphics processing units (GPUs) are included as a part of computer, video game, car navigation, and other electronic systems in order to generate graphics images on a monitor or other display device. The first GPUs to be developed stored pixel values, that is, the actual displayed colors, in a local memory, referred to as a frame buffer.

Since that time, the complexity of GPUs, in particular the GPUs designed and developed by NVIDIA Corporation of Santa Clara, Calif., has increased tremendously. Data stored in frame buffers has similarly increased in size and complexity. This graphics data now includes not only pixel values, but also textures, texture descriptors, shader program instructions, and other data and commands. These frame buffers are now often referred to as graphics memories, in recognition of their expanded roles.

Until recently, GPUs have communicated with central processing units and other devices in computer systems over an advanced graphics port, or AGP bus. While faster versions of this bus were developed, it was not capable of delivering sufficient graphics data to the GPU. Accordingly, the graphics data was stored in a local memory that was available to the GPU without having to go through the AGP port. Fortunately, a new bus has been developed, an enhanced version of the peripheral component interconnect (PCI) standard, or PCIE (PCI express). This bus protocol and resulting implementation have been greatly improved and refined by NVIDIA Corporation. This in turn has allowed the elimination of the local memory in favor of a system memory that is accessed via the PCIE bus.

Various complications arise as a result of the change in graphics memory location. One is that the GPU tracks data storage locations using virtual addresses, while the system memory uses physical addresses. To read data from the system memory, the GPU translates its virtual addresses into physical addresses. If this translation takes excessive time, data may not be provided to the GPU by the system memory at a sufficiently fast pace. This is particularly true as to pixel or display data, which must be consistently and quickly provided to the GPU.

This address translation may take excessive time if information needed to translate virtual addresses to physical addresses is not stored on the GPU. Specifically, if this translation information is not available on the GPU, a first memory access is required to retrieve it from the system memory. Only then can the display or other needed data be read from the system memory in a second memory access. Accordingly, the first memory accesses is in series before the second memory access since the second memory access cannot proceed without the address provided by the first memory access. The additional first memory access can be as long as 1 usec, greatly slowing the rate at which display or other needed data is read.

Thus, what is needed are circuits, methods, and apparatus that eliminate or reduce these extra memory accesses to retrieve address translation information from system memory.

### SUMMARY

Accordingly, embodiments of the present invention provide circuits, methods, and apparatus that eliminate or reduce system memory accesses to retrieve address translation information required for system memory display data accesses. Specifically, address translation information is stored on a graphics processor. This reduces or eliminates the need for separate system memory accesses to retrieve the translation information. Since the additional memory accesses are not needed, the processor can more quickly translate addresses and read the required display or other data from the system memory.

An exemplary embodiment of the present invention eliminates or reduces system memory accesses for address translation information following a power-up by pre-populating a cache referred to as a graphics translation look-aside buffer (graphics TLB) with entries that can be used to translate virtual addresses used by a GPU to physical addresses used by a system memory. In a specific embodiment of the present invention, the graphics TLB is pre-populated with address information needed for display data, though in other embodiments of the present invention addresses for other types of data may also pre-populate the graphics TLB. This prevents additional system memory accesses that would otherwise be needed to retrieve the necessary address translation information.

After power-up, to ensure that needed translation information is maintained on the graphics processor, entries in the graphics TLB that are needed for display access are locked or otherwise restricted. This may be done by limiting access to certain locations in the graphics TLB, by storing flags or other identifying information in the graphics TLB, or by other appropriate methods. This prevents overwriting data that would need to be read once again from the system memory.

Another exemplary embodiment of the present invention eliminates or reduces memory accesses for address translation information by storing a base address and an address range for a large contiguous block of system memory provided by a system BIOS. At power-up or other appropriate event, a system BIOS allocates a large memory block, which may be referred to as a “carveout,” to the GPU. The GPU may use this for display or other data. The GPU stores the base address and range on chip, for example, in hardware registers.

When a virtual address used by the GPU is to be translated to a physical address, a range check is done to see if the virtual address is in the range of the carveout. In a specific embodiment of the present invention, this is simplified by having the base address of the carveout correspond to a virtual address of zero. The highest virtual address in the carveout then corresponds to the range of physical addresses. If the address to be translated is in the range of virtual addresses for the carveout, the virtual address can be translated to a physical address by adding the base address to the virtual address. If the address to be translated is not in this range, it may be translated using a graphics TLB or page tables.

Various embodiments of the present invention may incorporate one or more of these or the other features described herein. A better understanding of the nature and advantages of the present invention may be gained with reference to the following detailed description and the accompanying drawings.

### BRIEF DESCRIPTION OF THE DRAWINGS

FIG. 1 is a block diagram of a computing system that is improved by incorporating an embodiment of the present invention;

FIG. 2 is a block diagram of another computing system that is improved by incorporating an embodiment of the present invention;

FIG. 3 is a flowchart illustrating a method of accessing display data stored in a system memory according to an embodiment of the present invention;

FIGS. 4A-C illustrate transfers of commands and data in a computer system during a method of accessing display data according to an embodiment of the present invention;

FIG. 5 is a flowchart illustrating another method of accessing display data in a system memory according to an embodiment of the present invention;

FIG. 6 illustrates the transfer of commands and data in a computer system during a method of accessing display data according to an embodiment of the present invention;

FIG. 7 is a block diagram of a graphics processing unit consistent with an embodiment of the present invention; and

FIG. 8 is a diagram of a graphics card according to an embodiment of the present invention.

### DESCRIPTION OF EXEMPLARY EMBODIMENTS

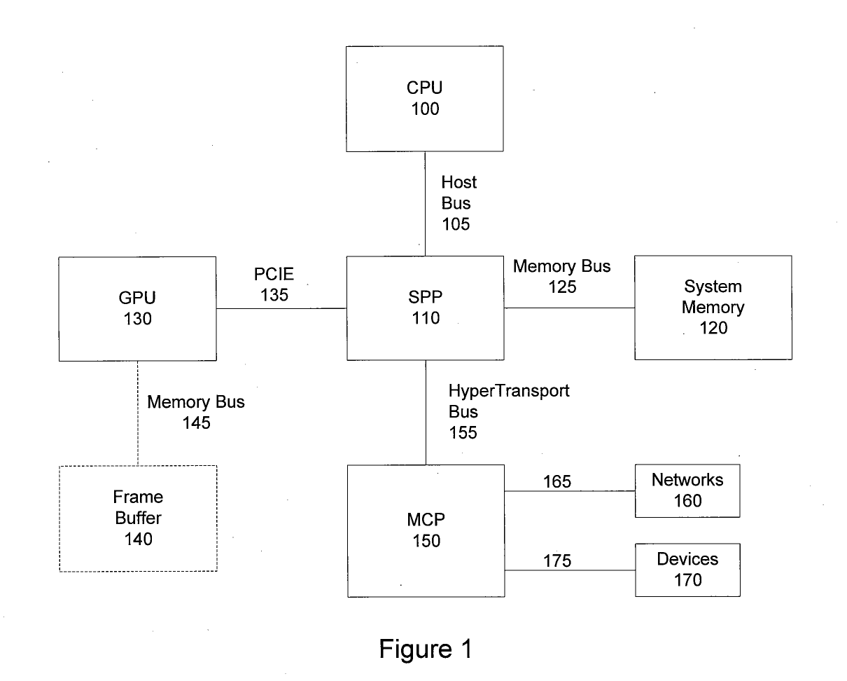

FIG. 1 is a block diagram of a computing system that is improved by the incorporation of an embodiment of the present invention. This block diagram includes a central processing unit (CPU) or host processor 100, system platform processor (SPP) 110, system memory 120, graphics processing unit (GPU) 130, media communications processor (MCP) 150, networks 160, and internal and peripheral devices 270. A frame buffer, local, or graphics memory 140 is also included, but shown by dashed lines. The dashed lines indicate that while conventional computer systems include this memory, embodiments of the present invention allow its removal. This figure, as with the other included figures, is shown for illustrative purposes only, and does not limit either the possible embodiments of the present invention or the claims.

The CPU 100 connects to the SPP 110 over the host bus 105. The SPP 110 is in communication with the graphics processing unit 130 over a PCIE bus 135. The SPP 110 reads and writes data to and from the system memory 120 over the memory bus 125. The MCP 150 communicates with the SPP 110 via a high-speed connection such as a HyperTransport bus 155, and connects network 160 and internal and peripheral devices 170 to the remainder of the computer system. The graphics processing unit 130 receives data over the PCIE bus 135 and generates graphic and video images for display over a monitor or other display device (not shown). In other embodiments of the present invention, the graphics processing unit is included in an Integrated Graphics Processor (IGP), which is used in place of the SPP 110. In still other embodiments, a general purpose GPU can be use as the GPU 130.

The CPU 100 may be a processor, such as those manufactured by Intel Corporation or other suppliers, which are well-known by those skilled in the art. The SPP 110 and MCP 150 are commonly referred to as a chipset. The system memory 120 is often a number of dynamic random access memory devices arranged in a number of the dual in-line memory modules (DIMMs). The graphics processing unit 130, SPP 110, MCP 150, and IGP, if used, are preferably manufactured by NVIDIA Corporation.

The graphics processing unit 130 may be located on a graphics card, while the CPU 100, system platform processor 110, system memory 120, and media communications processor 150 may be located on a computer system motherboard. The graphics card, including the graphics processing unit 130, is typically data printed circuit board with the graphics processing unit attached. The printed circuit board typically includes a connector, for example a PCIE connector, also attached to the printed circuit board, that fits into a PCIE slot included on the motherboard. In other embodiments of the present invention, the graphics processor is included on the motherboard, or subsumed into an IGP.

A computer system, such as the illustrated computer system, may include more than one GPU 130. Additionally, each of these graphics processing units may be located on separate graphics cards. Two or more of these graphics cards may be joined together by a jumper or other connection. One such technology, the pioneering SLI™, has been developed by NVIDIA Corporation. In other embodiments of the present invention, one or more GPUs may be located on one or more graphics cards, while one or more others are located on the motherboard.

In previously developed computer systems, the GPU 130 communicated with the system platform processor 110 or other device, at such as a Northbridge, via an AGP bus. Unfortunately, the AGP buses were not able to supply the needed data to the GPU 130 at the required rate. Accordingly, a frame buffer 140 was provided for the GPU's use. This memory allowed access to data without the data having to traverse the AGP bottleneck.

Faster data transfer protocols, such as PCIE and HyperTransport, have now become available. Notably, an improved PCIE interface has been developed by NVIDIA Corporation. Accordingly, the bandwidth from the GPU 130 to the system memory 120 has been greatly increased. Thus, embodiments of the present invention provide and allow for the removal of the frame buffer 140. Examples of further methods and circuits that may be used in the removal of the frame buffer can be found in co-pending and co-owned U.S. patent application Ser. No. 11/253,438, filed Oct. 18, 2005, titled Zero Frame Buffer, which is incorporated by reference.

The removal of the frame buffer that is allowed by embodiments of the present invention provide a savings that includes not only the absence of these DRAMs, but additional savings as well. For example, a voltage regulator is typically used to control the power supply to the memories, and capacitors are used to provide power supply filtering. Removal of the DRAMs, regulator, and capacitors provides a cost savings that reduces the bill of materials (BOM) for the graphics card. Moreover, board layout is simplified, board space is reduced, and graphics card testing is simplified. These factors reduce research and design, and other engineering and test costs, thereby increasing the gross margins for graphics cards incorporating embodiments of the present invention.

While embodiments of the present invention are well-suited to improving the performance of zero frame buffer graphics processors, other graphics processors, including those with limited or on-chip memories or limited local memory, may also be improved by the incorporation of embodiments of the present invention. Also, while this embodiment provides a specific type computer system that may be improved by the incorporation of an embodiment of the present invention, other types of electronic or computer systems may also be improved. For example, video and other game systems, navigation, set-top boxes, pachinko machines, and other types of systems may be improved by the incorporation of embodiments of the present invention.

Also, while these types of computer systems, and the other electronic systems described herein, are presently commonplace, other types of computer and other electronic systems are currently being developed, and others will be developed in the future. It is expected that many of these may also be improved by the incorporation of embodiments of the present invention. Accordingly, the specific examples listed are explanatory in nature and do not limit either the possible embodiments of the present invention or the claims.

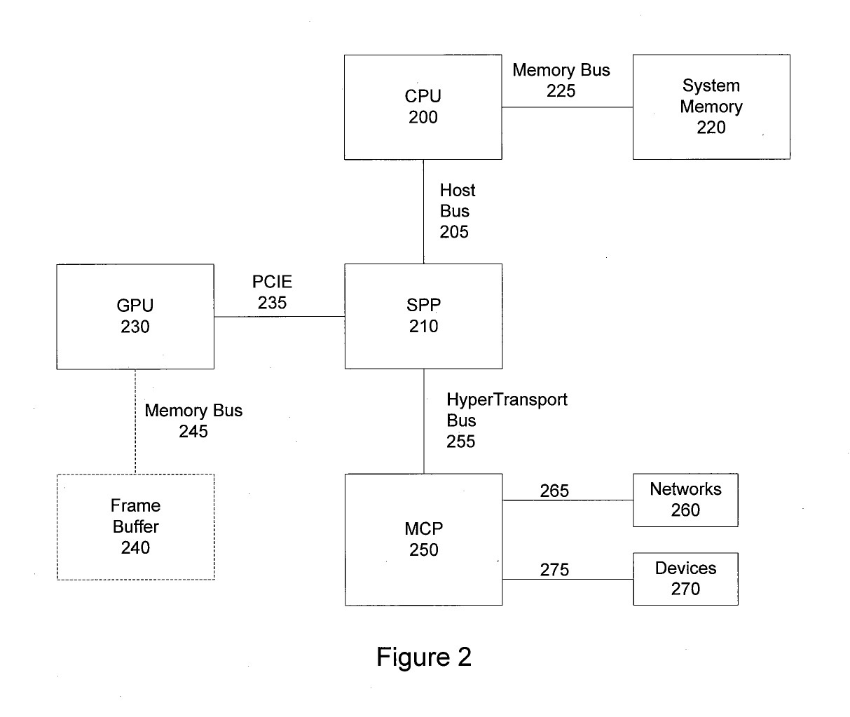

FIG. 2 is a block diagram of another computing system that is improved by incorporating an embodiment of the present invention. This block diagram includes a central processing unit or host processor 200, SPP 210, system memory 220, graphics processing unit 230, MCP 250, networks 260, and internal and peripheral devices 270. Again, a frame buffer, local, or graphics memory 240 is included, but with dashed lines to highlight its removal.

The CPU 200 communicates with the SPP 210 via the host bus 205 and accesses the system memory 220 via the memory bus 225. The GPU 230 communicates with the SPP 210 over the PCIE bus 235 and the local memory over memory bus 245. The MCP 250 communicates with the SPP 210 via a high-speed connection such as a HyperTransport bus 255, and connects network 260 and internal and peripheral devices 270 to the remainder of the computer system.

As before, the central processing unit or host processor 200 may be one of the central processing units manufactured by Intel Corporation or other supplier and are well-known by those skilled in the art. The graphics processor 230, integrated graphics processor 210, and media and communications processor 240 are preferably provided by NVIDIA Corporation.

The removal of the frame buffers 140 and 240 in FIGS. 1 and 2, and the removal of other frame buffers in other embodiments of the present invention, is not without consequence. For example, difficulties arise regarding the addresses used to store and read data from the system memory.

When a GPU uses a local memory to store data, the local memory is strictly under the control of the GPU. Typically, no other circuits have access to the local memory. This allows the GPU to keep track of and allocate addresses in whatever manner it sees fit. However, a system memory is used by multiple circuits and space is allocated to those circuits by the operating system. The space allocated to a GPU by an operating system may form one contiguous memory section. More likely, the space allocated to a GPU is broken up into many blocks or sections, some of which may have different sizes. These blocks or sections can be described by an initial, starting, or base address and a memory size or range of addresses.

It is difficult and unwieldy for a graphics processing unit to use actual system memory addresses, since the addresses that are provided to the GPU are allocated in multiple independent blocks. Also, the addresses that are provided to the GPU may change each time the power is turned on or memory addresses are otherwise reallocated. It is much easier for software running on the GPU to use virtual addresses that are independent of actual physical addresses in the system memory. Specifically, GPUs treat memory space as one large contiguous block, while memory is allocated to the GPU in several smaller, disparate blocks. Accordingly, when data is written to or read from the system memory, a translation between the virtual addresses used by the GPU and the physical addresses used by the system memory is performed. This translation can be performed using tables, whose entries include virtual addresses and their corresponding physical address counterparts. These tables are referred to as page tables, while the entries are referred to as page-table entries (PTEs).

The page tables are too large to put on a GPU; to do so is undesirable due to cost constraints. Accordingly, the page tables are stored in the system memory. Unfortunately, this means that each time data is needed from the system memory, a first or additional memory access is needed to retrieve the required page-table entry, and a second memory access is needed to retrieve the required data. Accordingly, in embodiments of the present invention, some of the data in the page tables are cached in a graphics TLB on the GPU.

When a page-table entry is needed, and the page-table entry is available in a graphics TLB on the GPU, a hit is said to have occurred, and the address translation can proceed. If the page-table entry is not stored in the graphics TLB on the GPU, a miss is said to have occurred. At this point, the needed page-table entry is retrieved from the page tables in the system memory.

After the needed page-table entry has been retrieved, there is a high likelihood that this same page-table entry will be needed again. Accordingly, to reduce the number of memory accesses, it is desirable to store this page-table entry in the graphics TLB. If there are no empty locations in the cache, a page-table entry that has not been recently used may be overwritten or evicted in favor of this new page-table entry. In various embodiments of the present invention, before eviction, a check is done to determine whether the entry currently cached was modified by the graphics processing unit after it was read from the system memory. If it was modified, a write-back operation, where the updated page-table entry is written back to the system memory, takes place before the new page-table entry overwrites it in the graphics TLB. In other embodiments of the present invention, this write-back procedure is not performed.

In a specific embodiment of the present invention, the page tables are indexed based on the smallest granularity that the system might allocate, e.g. a PTE could represent a minimum of 44 KB blocks or pages. Therefore, by dividing a virtual address by 16 KB and then multiplying by the size of an entries generates the index of interest in the page table. After a graphics TLB miss, the GPU uses the above index to find the page table entry. In this specific embodiment, the page table entry may map one or more blocks which are larger than 4 KB. For example, a page table entry may map a minimum of four 4 KB blocks, and can map, 4, 8, or 16 blocks of larger than 4 KB up to a maximum total of 256 KB. Once such a page-table entry is loaded into the cache, the graphics TLB can find a virtual address within that 256 KB by referencing a single graphics TLB entry, which is a single PTE. In this case, the page table itself is arranged as 16 byte entries, each of which map at least 16 KB. Therefore, the 256 KB page-table entry is replicated at every page table location that falls within that 256 KB of virtual address space. Accordingly, in this example, there are 16 page table entries with precisely the same information. A miss within the 256 KB reads one of those identical entries.

As mentioned above, if a needed page-table entry is not available in the graphics TLB, an extra memory access is required to retrieve the entry. For specific graphics functions that require a steady, consistent access to data, these extra memory accesses are very undesirable. For example, a graphics processing unit requires a reliable access to display data such than it can provide image data to a monitor at a required rate. If excessive memory accesses are needed, the resulting latency may interrupt the flow of pixel data to the monitor, thereby disrupting the graphics image.

Specifically, if address translation information for a display data access needs to be read from system memory, that access is in series with the subsequent data access, that is, the address translation information must be read from memory so the GPU can learn where the needed display data is stored. The extra latency caused by this extra memory access reduces the rate at which display data can be provided to the monitor, again disrupting the graphics image. These extra memory accesses also increase traffic on the PCIE bus and waste system memory bandwidth.

Extra memory reads to retrieve address translation information is particularly likely at power-up or other events when the graphics TLB is empty or cleared. Specifically, at power-up of a computer system, the basic input/output system (BIOS) expects the GPU to have a local frame buffer memory at its disposal. Thus, in conventional systems, the system BIOS does not allocate space in the system memory for use by the graphics processor. Rather, the GPU requests a certain amount of system memory space from the operating system. After memory space is allocated by the operating system, the GPU can store page-table entries in the page tables in the system memory, but the graphics TLB is empty. As display data is needed, each request for a PTE results in a miss that further results in an extra memory access.

Accordingly, embodiments of the present invention pre-populate the graphics TLB with page-table entries. That is, the graphics TLB is filled with page-table entries before requests needing them result in cache misses. This pre-population typically includes at least page-table entries needed for the retrieval of display data, though other page-table entries may also pre-populate the graphics TLB. Further, to prevent page-table entries from being evicted, some entries may be locked or otherwise restricted. In a specific embodiment of the present invention, page-table entries needed for display data are locked or restricted, though in other embodiments, other types of data may be locked or restricted. A flowchart illustrating one such exemplary embodiment is shown in the following figure.

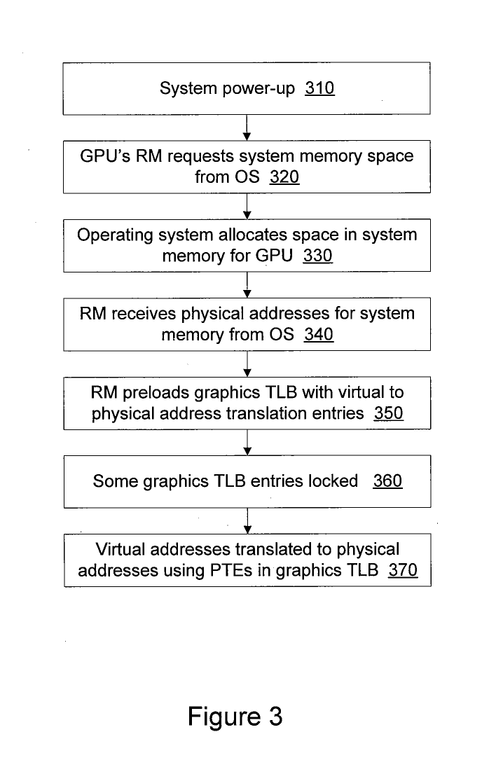

FIG. 3 is a flowchart illustrating a method of accessing display data stored in a system memory according to an embodiment of the present invention. This figure, as with the other included figures, is shown for illustrative purposes and does not limit either the possible embodiment of the present invention or the claims. Also, while this and the other examples shown here are particularly well-suited for accessing display data, other types or data accesses can be improved by the incorporation of embodiments of the present invention.

In this method, a GPU, or, more specifically, a driver or resource manager running on the GPU, ensures that the virtual addresses can be translated to physical addresses using translation information stored on the GPU itself, without the need to retrieve such information from the system memory. This is accomplished by initially pre-populating or preloading translation entries in a graphics TLB. The addresses associated with display data are then locked or otherwise prevented from being overwritten or evicted.

Specifically, in act 310, the computer or other electronic system is powered up, or experiences a reboot, power reset, or similar event. In act 320, a resource manager, which is part of a driver running on the GPU, requests system memory space from the operating system. The operating system allocates space in the system memory for the CPU in act 330

While in this example, the operating system running on the CPU is responsible for the allocation of frame buffer or graphics memory space in the system memory, in various embodiments of the present invention, drivers or other software running on the CPU or other device in the system may be responsible for this task. In other embodiments, this task is shared by both the operating system and one or more of the drivers or other software. In act 340, the resource manager receives the physical address information for the space in the system memory from the operating system. This information will typically include at least the base address and size or range of one or more sections in the system memory.

The resource manager may then compact or otherwise arrange this information so as to limit the number of page-table entries that are required to translate virtual addresses used by the GPU into physical addresses used by the system memory. For example, separate but contiguous blocks of system memory space allocated for the GPU by the operating system may be combined, where a single base address is used as a starting address, and virtual addresses are used as an index signal. Examples showing this can be found in co-pending and co-owned U.S. patent application Ser. No. 11/077,662, filed Mar. 10, 2005, titled Memory Management for Virtual Address Space with Translation Units of Variable Range Size, which is incorporated by reference. Also, while in this example, this task is the responsibility of a resource manage that it part of a driver running on a GPU; in other embodiments, this and the other tasks shown in this and the other included examples may be done or shared by other software, firmware, or hardware.

In act 350, the resource manager writes translation entries to the page tables in the system memory. The resource manager also preloads or pre-populates the graphics TLB with at least some of these translation entries. In act 360, some or all of the graphics TLB entries can be locked or otherwise prevented from being evicted. In a specific embodiment of the present invention, addresses for displayed data are prevented from being overwritten or evicted to ensure that addresses for display information can be provided without additional system memory accesses being needed for address translation information.

This locking may be achieved using various methods consistent with embodiments of the present invention. For example, where a number of clients can read data from the graphics TLB, one or more of these clients can be restricted such that they cannot write data to restricted cache locations, but rather must write to one of a number of pooled or unrestricted cache lines. More details can be found in co-pending and co-owned U.S. patent application Ser. No. 11/298,256, filed Dec. 8, 2005, titled Shared Cache with Client-Specific Replacement Policy, which is incorporated by reference. In other embodiments, other restrictions can be placed on circuits that can write to the graphics TLB, or data such as a flag can be stored with the entries in the graphics TLB. For example, the existence of some cache lines may be hidden from circuits that can write to the graphics TLB. Alternately, if a flag is set, the data in the associated cache line cannot be overwritten or evicted.

In act 370, when display or other data is needed from system memory, the virtual addresses used by the GPU are translated into physical addresses using page-table entries in the graphics TLB. Specifically, a virtual address is provided to the graphics TLB, and the corresponding physical address is read. Again, if this information is not stored in the graphics TLB, it needs to be requested from the system memory before the address translation can occur.

In various embodiments of the present invention, other techniques may be included to limit the effects of a graphics TLB miss. Specifically, additional steps can be taken to reduce the memory access latency time, thereby reducing the effect of a cache miss on the supply of display data. One solution is to make use of the virtual channel VC1 that is part of the PCIE specification. If graphics TLB miss uses virtual channel VC1, it could bypass other requests, allowing the needed entry to be retrieved more quickly. However, conventional chip sets do not allow access to the virtual channel VC1. Further, while NVIDIA Corporation could implement such a solution in a product in manner consistent with the present invention, interoperability with other devices makes it undesirable to do so at the present time, though in the future this may change. Another solution involves prioritizing or tagging requests resulting from graphics TLB misses. For example, a request could be flagged with a high-priority tag. This solution has similar interoperability concerns as the above solution.

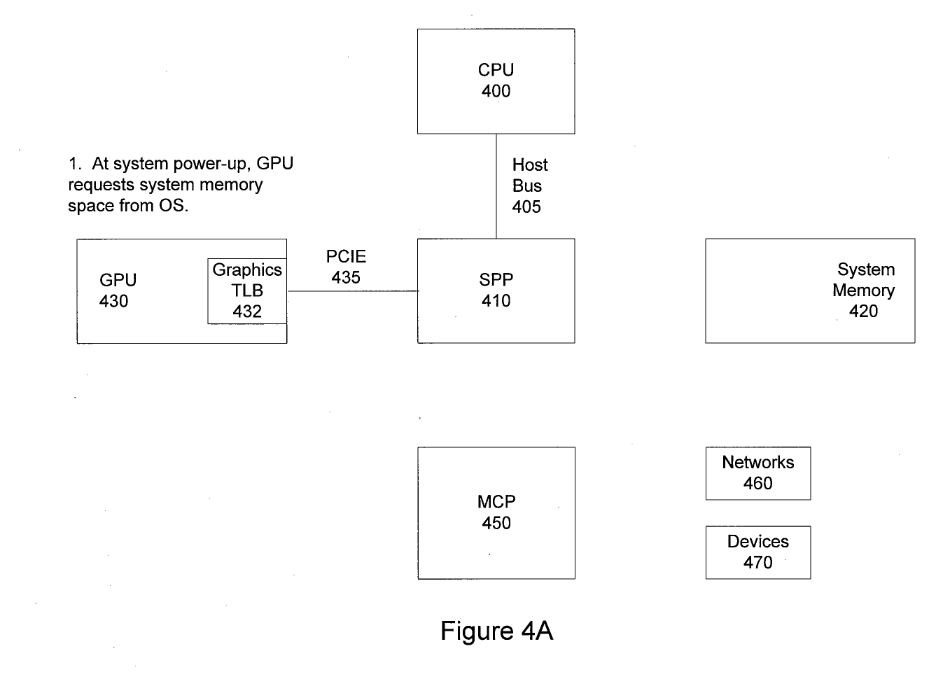

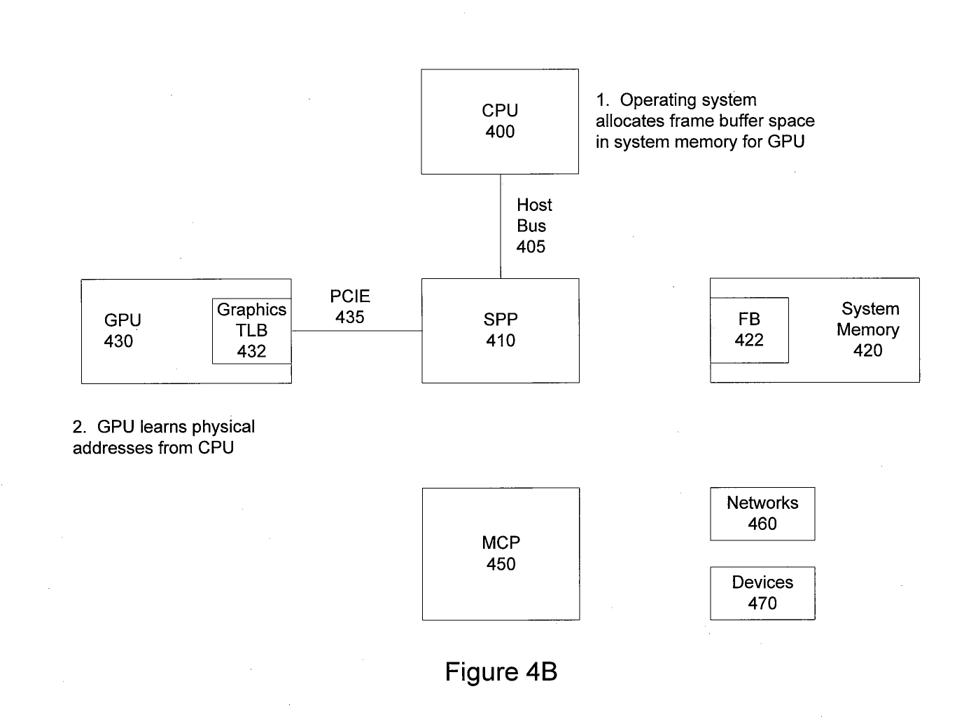

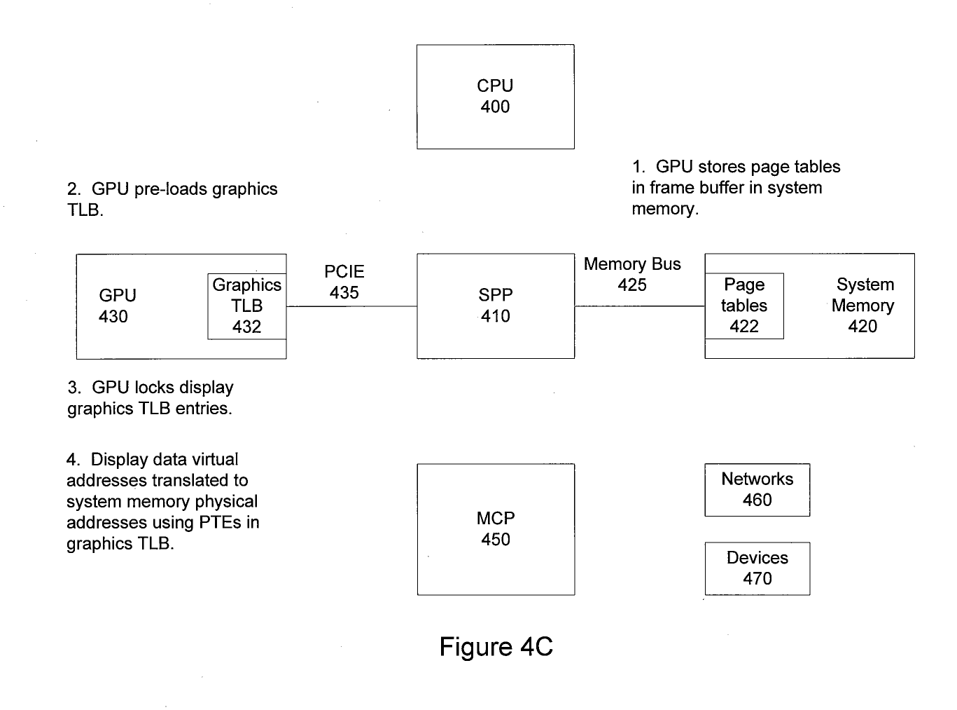

FIGS. 4A-C illustrate transfers of commands and data in a computer system during a method of accessing display data according to an embodiment of the present invention. In this specific example, the computer system of FIG. 1 is shown, though command and data transfers in other systems, such as the system shown in FIG. 2, are similar.

In FIG. 4A, at system power-up, reset, reboot, or other event, the GPU sends a request for system memory space to the operating system. Again, this request may come from a driver operating on the GPU, specifically a resource manager portion of the driver may make this request, though other hardware, firmware, or software can make this request. This request may be passed from the GPU 430 through the system platform processor 410 to the central processing unit 400.

In FIG. 4B, the operating system allocates space for the GPU in the system memory for use as the frame buffer or graphics memory 422. The data stored in the frame buffer or graphics memory 422 may include display data, that is, pixel values for display, textures, texture descriptors, shader program instructions, and other data and commands.

In this example, the allocated space, the frame buffer 422 in system memory 420, is shown as being contiguous. In other embodiments or examples, the allocated space may be noncontiguous, that is, it may be disparate, broken up into multiple sections.

Information that typically includes one or more base addresses and ranges of sections of the system memory is passed to the GPU. Again, in a specific embodiment of the present invention, this information is passed to a resource manager portion of a driver operating on the GPU 430, though other software, firmware, or hardware can be used. This information may be passed from the CPU 400 to the GPU 430 via the system platform processor 410.

In FIG. 4C, the GPU writes translation entries in the page tables in the system memory. The GPU also preloads the graphics TLB with at least some of these translation entries. Again, these entries translate virtual addresses that used by the GPU into physical addresses used by the frame buffer 422 in the system memory 420.

As before, some of the entries in the graphics TLB may be locked or otherwise restricted such that they cannot be evicted or overwritten. Again, in a specific embodiment of the present invention, entries translating the addresses identifying locations in the frame buffer 422 where pixel or display data is stored are locked or otherwise restricted.

When data is needed to be accessed from the frame buffer 422, virtual addresses used by the GPU 430 are translated into physical addresses using the graphics TLB 432. These requests are then transferred to the system platform processor 410, which reads the required data and returns it to the GPU 430.

In the above examples, following a power-up or other power reset or similar condition, the GPU sends a request to the operating system for space in the system memory. In other embodiments of the present invention, the fact that the GPU will need space in the system memory is known and a request does not need to be made. In this case, a system BIOS, operating system, or other software, firmware, or hardware, may allocate space in the system memory following a power-up, reset, reboot, or other appropriate event. This is particularly feasible in a controlled environment, such as a mobile application where GPUs are not readily swapped or substituted, as they often are in a desktop application.

The GPU may already know the addresses that it is to use in the system memory, or the addresses information may be passed to the GPU by the system BIOS or operating system. In either case, the memory space may be a contiguous portion of memory, in which case only a single address, the base address, needs to be known or provided to the GPU. Alternately, the memory space may be disparate or noncontiguous, and multiple addresses may need to be known or provided to the GPU. Typically, other information, such as memory block size or range information, is also passed to or known by the GPU.

Also, in various embodiments of the present invention, space in the system memory may be allocated by the system by an operating system at power-up and the GPU may make a request for more memory at a later time. In such an example, both the system BIOS and operating system may allocate space in the system memory for use by the GPU. The following figure shows an example of an embodiment of the present invention where a system BIOS is programmed to allocate system memory space for a GPU at power-up.

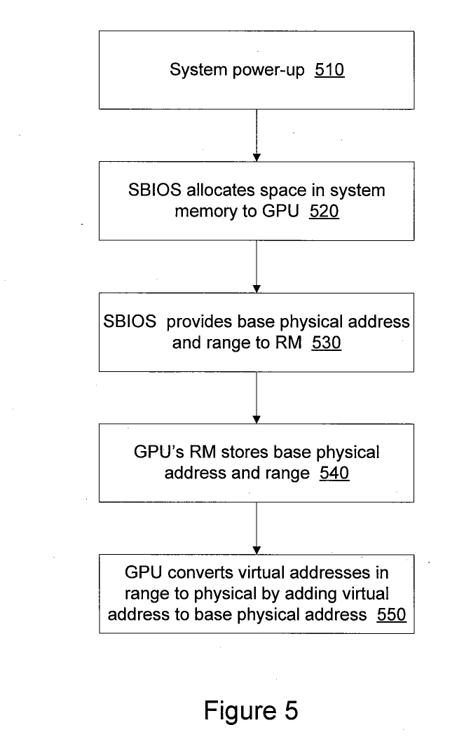

FIG. 5 is a flowchart illustrating another method of accessing display data in a system memory according to an embodiment of the present invention. Again, while embodiments of the present invention are well-suited to provide access to display data, various embodiments may provide access to this or other types of data. In this example, the system BIOS knows at power-up that space in the system memory needs to be allocated for use by the GPU. This space may be contiguous or noncontiguous. Also in this example, the system BIOS passes memory and address information to a resource manager or other portion of a driver on a GPU, though in other embodiments of the present invention, the resource manager or other portion of a driver on the GPU may be aware of the address information ahead of time.

Specifically, in act 510, the computer or other electronic system powers up. In act 520, the system BIOS or other appropriate software, firmware, or hardware, such at the operating system, allocates space in the system memory for use by the GPU. If the memory space is contiguous, the system BIOS provides a base address to a resource manager or driver running on a GPU. If the memory space is noncontiguous, the system BIOS will provide a number of base addresses. Each base address is typically accompanied by memory block size information, such as size or address range information. Typically, the memory space is a carveout, a contiguous memory space. This information is typically accompanied by address range information.

The base address and range are stored for use on the GPU in act 540. Subsequent virtual addresses can be converted to physical addresses in act 550 by using the virtual addresses an index. For example, in a specific embodiment of the present invention, a virtual address can be converted to a physical address by adding the virtual address to the base address.

Specifically, when a virtual address is to be translated to a physical address, a range check is performed. When the stored physical base address corresponds to a virtual address of zero, if the virtual address is in the range, the virtual address can be translated by summing it with the physical base address. Similarly, when the stored physical base address corresponds with a virtual address of “X”, if the virtual address is in the range, the virtual address can be translated by summing it with the physical base address and subtracting “X.” If the virtual address is not in the range, the address can be translated using the graphics TLB or page-table entries as described above.

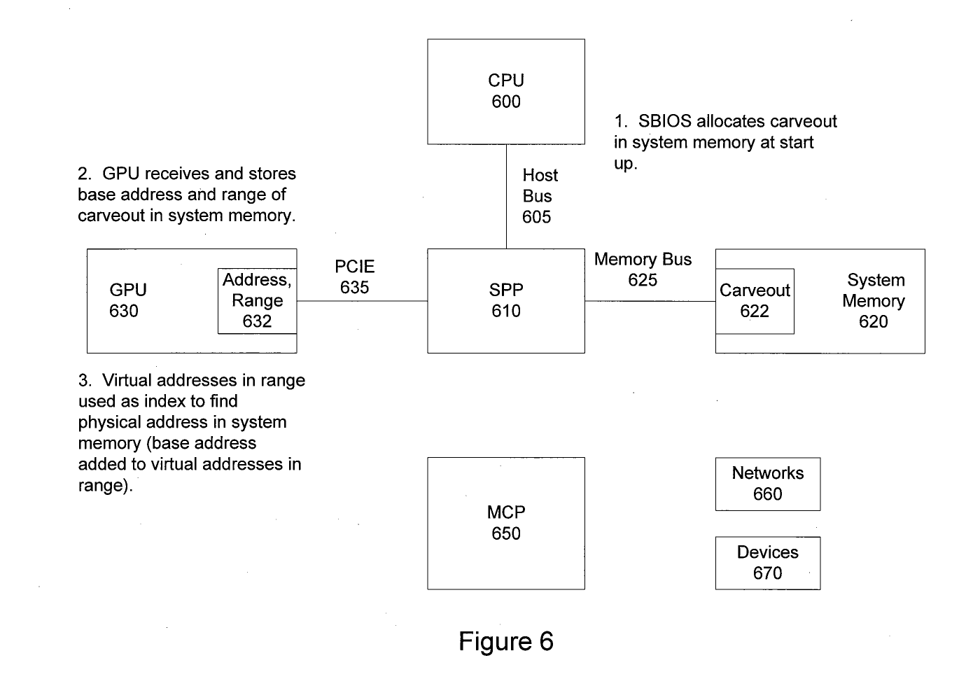

FIG. 6 illustrates the transfer of commands and data in a computer system during a method of accessing display data according to an embodiment of the present invention. At power-up, the system BIOS allocates space, a “carveout” 622 in the system memory 624 use by the GPU 630.

The GPU receives and stores the base address (or base addresses) for allocated space or carveout 622 in the system memory 620. This data may be stored in the graphics TLB 632, or it may be stored elsewhere, for example in a hardware register, on the GPU 630. This address is stored, for example in a hardware register, along with the range of the carveout 622.

When data is to be read from the frame buffer 622 in the system memory 620, the virtual addresses used by the GPU 630 can be converted to physical addresses used by the system memory by treating the virtual addresses as an index. Again, in a specific embodiment of the present invention, virtual addresses in the carveout address range are translated to physical addresses by adding the virtual address to the base address. That is, if the base address corresponds to a virtual address of zero, virtual addresses can be converted to physical by adding them to the base address as described above Again, virtual addresses outside the range can be translated using graphics TLBs and page tables as described above.

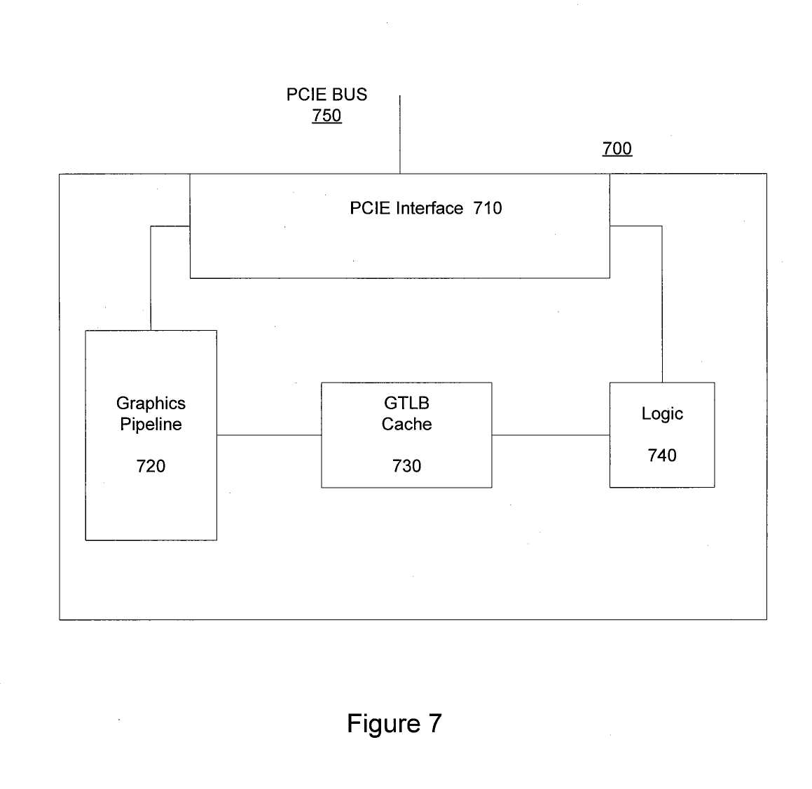

FIG. 7 is a block diagram of a graphics processing unit consistent with an embodiment of the present invention. This block diagram of a graphics processing unit 700 includes a PCIE interface 710, graphics pipeline 720, graphics TLB 730, and logic circuit 740. The PCIE interface 710 transmits and receives data over the PCIE bus 750. Again, in other embodiments of the present invention, other types of buses currently developed or being developed, and those that will be developed in the future, may be used. The graphics processing unit is typically formed on an integrated circuit, though in some embodiments more than one integrated circuit may comprise the GPU 700.

The graphics pipeline 720 receives data from the PCIE interface and renders data for display on a monitor or other device. The graphics TLB 730 stores page-table entries that are used to translate virtual memory addresses used by the graphics pipeline 720 to physical memory accesses used by the system memory. The logic circuit 740 controls the graphics TLB 730, checks for locks or other restrictions on the data stored there, and reads data from and writes data to the cache.

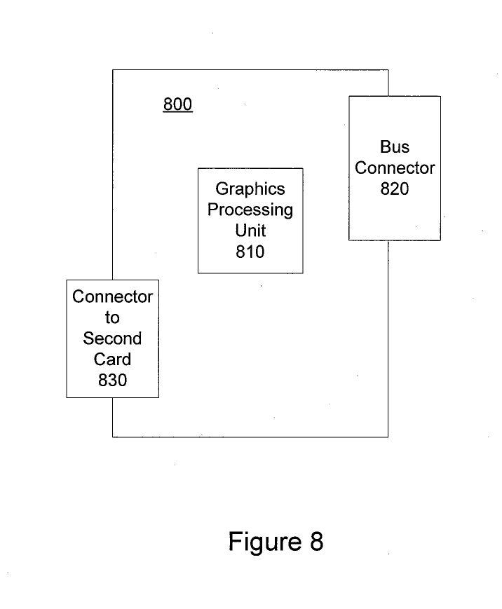

FIG. 8 is a diagram illustrating a graphics card according to an embodiment of the present invention. The graphics card 800 includes a graphics processing unit 810, a bus connector 820, and a connector to a second graphics card 830. The bus connector 828 may be a PCIE connector designed to fit a PCIE slot, for example a PCIE on slot on a computer system's motherboard. The connector to a second card 830 may be configured to fit a jumper or other connection to one or more other graphics cards. Other devices, such as a power supply regulator and capacitors, may be included. It should be noted that a memory device is not included on this graphics card.

The above description of exemplary embodiments of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications to thereby enable others skilled in the art to best utilize the invention in various embodiments and with various modifications as are suited to the particular use contemplated.

What is claimed is:

1. A method of retrieving data using a graphics processor comprising:
requesting access to memory locations in a system memory;
receiving address information for at least one block of memory locations in the system memory, the address information including information identifying at least one physical memory address; and
storing a page table-entry corresponding to the physical memory address in a cache;
wherein the address information is received and the page-table entry is stored in the cache without waiting for a cache miss.

2. The method of claim 1 further comprising:
storing the page table-entry in the system memory.

3. The method of claim 2 further comprising:
locking the location in the cache where the page-table entry is stored.

4. The method of claim 3 wherein the graphics processor is a graphics processing unit.

5. The method of claim 3 wherein the graphics processor is included on an integrated graphics processor.

6. The method of claim 3 wherein the request for access to memory location in a system memory is made to an operating system.

7. The method of claim 3 wherein the information identifying at least one physical memory address comprises a base address and a memory block size.

8. A graphics processor comprising:
a data interface for providing a request for access to memory locations in a system memory and for receiving address information regarding memory locations in the system memory, the address information including information identifying at least one physical memory address;
a cache controller for writing a page-table entry corresponding to the physical memory address; and
a cache for storing the page-table entry,
wherein the address information is received and the page-table entry is stored in the cache without waiting for a cache miss to occur.

9. The graphics processor of claim 8 wherein the data interface also provides a request to store the page-table entry in the system memory.

10. The graphics processor of claim 8 wherein the data interface provides a request for access to memory locations in a system memory following a system power-up.

11. The graphics processor of claim 8 wherein the cache controller locks the location where the page-table entry is stored.

12. The graphics processor of claim 8 wherein the cache controller restricts access to the location where the virtual address and the physical address are stored.

13. The graphics processor of claim 8 wherein the data interface circuit is a PCIE interface circuit.

14. The graphics processor of claim 8 wherein the graphics processor is a graphics processing unit.

15. The graphics processor of claim 8 wherein the graphics processor is included on an integrated graphics processor.

16. A method of retrieving data using a graphics processor comprising:
receiving a base address and range for a block of memory in a system memory;
storing the base address and range;
receiving a first address;
determining if the first address is in the range, and if it is,
translating the first address to a second address by adding the base address to the first address, else
reading a page-table entry from a cache; and
translating the first address to a second address using the page-table entry.

17. The method of claim 16 further comprising, before reading a page-table entry from the cache, storing the page-table entry in the cache without waiting for a cache miss.

18. The method of claim 16 further comprising, before reading a page-table entry from the cache, determining if the page table is stored in the cache, and if it is not, reading the page-table entry from the system memory.

19. The method of claim 16 wherein the graphics processor is a graphics processing unit.

20. The method of claim 16 wherein the graphics processor is included on an integrated graphics processor.
